(19) United States
(12) Patent Application Publication
(10) Pub. No.: US 2019/0392309 A1
(43) Pub. Date: Dec. 26, 2019

(54) LSTM Training For Neural Network Based Course Of Action Selection

(71) Applicant: DENSO International America, Inc., Southfield, MI (US)

(72) Inventors: Shalabh BHATNAGAR, Farmington Hills, MI (US); Joseph LULL, South Haven, MI (US); Zhiyuan DU, West Bloomfield, MI (US); Rajesh MALHAN, Troy, MI (US)

(21) Appl. No.: 16/244,248

(22) Filed: Jan. 10, 2019

Related U.S. Application Data
(60) Provisional application No. 62/688,018, filed on Jun. 21, 2018.

(51) Int. Cl. G06N 3/08; G06N 20/00

(52) U.S. Cl. CPC G06N 3/08; G06N 20/00

(57) ABSTRACT

An AI system is provided and includes a long short term memory and data processing, feature selection, behavior recognition, parameter, and driver assistance modules. The data processing module, at a host vehicle: receives training data associated with features; based on the training data, determines candidate features using a synchronous sliding window; and indexes and ranks the candidate features. The feature selection module selects ones of the candidate features having higher priority than other ones of the candidate features and filters the training data of the selected features to provide filtered data. The behavior recognition module determines a behavior of a remote vehicle based on the filtered data. The parameter module determines a parameter of the remote vehicle based on the determined behavior. The long short term memory predicts a value of the parameter. The driver assistance module assists in operation of the host vehicle based on the predicted value.

### CROSS-REFERENCE TO RELATED APPLICATIONS

This application claims the benefit of U.S. Provisional Application No. 62/688,018, filed Jun. 21, 2018. The entire disclosure of the above application is incorporated herein by reference.

### FIELD

The present disclosure relates to artificial intelligence systems and more particularly to systems and methods for efficiently determining and following an accurate course of action.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles can include multiple control modules, such as an engine control module, a transmission control module, an infotainment control module, a navigation control module, etc. The control modules and/or other electronic devices can communicate with each other over a controller area network (CAN) bus. This may include transmission of CAN messages indicative of states of various parameters. A vehicle typically includes various sensors for detection of states of devices in the vehicle and conditions surrounding the vehicle. The sensors may include, for example, a steering wheel position sensor, a brake pedal position sensor, an accelerator position sensor, temperature sensors, a vehicle speed sensor, an engine speed sensor, cameras, radar sensors, lidar sensors, etc. Information from the sensors and other vehicle information may be shared with the control modules via CAN messages transmitted over the CAN bus. The vehicle information may also be shared among different vehicles in close proximity with each other using vehicle-to-vehicle communication.

A vehicle may be equipped with a driver assistance module to assist the driver in operating the vehicle. The driver assistance module may monitor host vehicle information and other vehicle information via, for example, CAN messages and determine parameters of the host vehicle and other vehicles and environmental conditions. Based on this information, the driver assistance module may assist the driver by generating, for example, warning signals and/or performing operations to brake, steer and/or control acceleration and speed of the vehicle. This may include, for example, maintaining the host vehicle in a traffic lane and/or merging the vehicle into an adjacent traffic lane to avoid a collision.

### SUMMARY

An artificial intelligence system is provided and includes a data processing module, a feature selection module, a behavior recognition module, one or more parameter modules, a long short term memory and a driver assistance module. The data processing module is configured to, at a host vehicle, (i) receive training data associated with features, (ii) based on the training data of the features, determine candidate features using a synchronous sliding window, and (iii) index and rank the candidate features. The feature selection module is configured to (i) select a predetermined number of the candidate features having higher priority than the other ones of the candidate features, and (ii) filtering the training data corresponding to the selected features to provide filtered data. The behavior recognition module is configured to determine a behavior of a remote vehicle based on the filtered data. The one or more parameter modules is configured to determine one or more parameters of the remote vehicle relative to the host vehicle based on the determined behavior. The long short term memory implements a neural network and is configured to receive the one or more parameters and predict one or more values of the one or more parameters. The driver assistance module is configured to assist in operation of the host vehicle based on the predicted values.

In other features, a method of operating an artificial intelligence system is provided. The method includes: receiving at a host vehicle training data associated with features; based on the training data of the features, determining candidate features using a synchronous sliding window; indexing and ranking the candidate features; selecting a predetermined number of the candidate features having higher priority than the other ones of the candidate features; and filtering the training data corresponding to the selected features to provide filtered data. The method further includes: determining a behavior of a remote vehicle based on the filtered data; determining one or more parameters of the remote vehicle relative to the host vehicle based on the determined behavior; implementing a neural network via a long short term memory; receiving the one or more parameters at the neural network and predicting one or more values of the one or more parameters; and assisting in operation of the host vehicle based on the predicted values.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a driver assistance system incorporating a vehicle control module having a training module, a cooperative action planning module, a long short term memory (LSTM) and an unlearning module in accordance with an embodiment of the present disclosure;

FIG. 2 is a functional block diagram of an example of an artificial intelligence system including first and second neural networks in accordance with an embodiment of the present disclosure;

FIG. 3 illustrates a LSTM operational method including a LSTM training method in accordance with an embodiment of the present disclosure;

FIG. 4 illustrates a course of action selection method implemented by the cooperative action planning module in accordance with an embodiment of the present disclosure;

FIG. 5 is a functional block diagram of an example of the second neural network in accordance with an embodiment of the present disclosure;

FIG. 6 is a functional block diagram of a weighting module in accordance with an embodiment of the present disclosure;

FIG. 7 is an example of accuracy over time plots illustrating detection of a negative slope and accuracy by maintaining previous weight set values in accordance with an embodiment of the present disclosure;

FIG. 8 is an example of lateral distance over time plots illustrating a reduced amount of time to predict a lane change event as a result of filtering data of selected features and in accordance with an embodiment of the present disclosure;

FIG. 9 illustrates a grading method in accordance with an embodiment of the present disclosure; and

FIG. 10 illustrates creating and updating groups of scores of actions performed for certain conditions in accordance with an embodiment of the present disclosure.

In the drawings, reference numbers may be reused to identify similar and/or identical elements.

### DETAILED DESCRIPTION

Recent intelligent vehicles include various sensors and communication devices, which are used to understand host vehicle behavior, driver behavior, and behavior of other vehicles. Driver assistance is provided based on outputs of the sensors, current operating conditions, and a detected operating environment. For example, a steering wheel angle, a brake pedal position, and an accelerator pedal position may be monitored to determine driver behavior while external radar sensor signals and camera images may be monitored to detect a current vehicle environment, which may include other vehicles. As an example, location and movement of lane markers, surrounding objects, signal lights, etc. may be monitored. Driver assistance may be provided to, for example, autonomously steer, brake and/or decelerate the corresponding host vehicle to prevent a collision. Conventional vehicles or vehicles that are less intelligent are not capable of providing a same level of driver assistance and/or are simply unable to provide any driver assistance. Thus, traffic may include vehicles that are fully autonomous, partially autonomous, and/or are not autonomous. This is referred to as mixed traffic.

A modular artificial intelligence (AI) system of a vehicle may perform autonomous actions and operate a vehicle to merge from a first lane of traffic into a second lane of traffic. A modular AI system is an AI system that is applicable to various vehicle environments and follows a set of rules to predict movement (e.g., travel path, speed, acceleration, etc. of nearby vehicles relative to a host vehicle). Traditional AI systems are based on “right” and “wrong” actions for providing an end result based on the set of rules. The AI systems are not capable of understanding an existing grey space of instances as can a human.

Traditional AI systems are also unable to handle uncertain events. As an example, uncertainty can exist when a host vehicle system is unable to determine whether a nearby vehicle will cooperate with the host vehicle with regards to taking future actions to avoid a collision. Traditional AI systems are also unaware of the intentions of other vehicle drivers (or future actions of the other vehicles). In addition, an assumption of certain traditional AI systems is that other nearby vehicles are at least partially autonomous and capable of cooperating with the host vehicle. However, it is often the case that the host vehicle is in a mixed traffic environment and/or an environment where no fully or partially autonomous vehicles, other than the host vehicle, are present. Another issue with traditional AI systems is the inability to perform training operations while handling corrupt data and/or data including local minimum.

The examples provided herein include hybrid AI cognitive systems (hereinafter referred to as “AI systems”) that are capable of performing an economical traffic lane merge. The AI systems are able to predict paths of the host vehicle and surrounding vehicles and make efficient course of action decisions to perform a merge operation independent of whether non-autonomous vehicles are present. The AI systems are able to handle situations not covered by a predetermined set of rules and thus are able to handle grey space instances. The AI systems are able to handle situations for which rules do not exist (i.e. are not stored in memory of the host vehicle). The AI systems are self-training systems, which perform self-training operation for situations not accounted for by stored rules.

The AI systems disclosed herein are able to predict intentions of drivers of vehicles and/or behavior of the vehicles using a long short term memory (LSTM). After predicting the behavior of the vehicles, a cooperative action planning module plans a course of action and instructs devices, such as indicators and actuators, to perform certain corresponding actions. The cooperative action planning module includes a scoring module and a grading module to improve and maximize operating efficiency. The AI systems include scoring modules and accuracy analyzing modules for determining: whether performed actions are right (or appropriate for a current situation) or wrong (or inappropriate for a current situation); and an accuracy level (or percentage right or wrong). This improves decision efficiency. The grading module aids in analyzing a situation more efficiently based on a level of accuracy of actions performed. This helps the AI systems to learn more efficiently and to make better decisions. Training is performed to train multiple neural networks of the LSTM and cooperative action planning module without changing or updating stored training rules more often than previously performed. The grading module provides self-modifying of a scaling algorithm based on environmental data. This is helpful for continuous training without human monitoring.

The disclosed AI systems also include unlearning modules for increasing accuracy of course of action decisions. The unlearning modules maintain at a minimum a last highest accuracy while neglecting corrupt data and preventing course of actions to be performed that decrease accuracy. Decreased accuracy is associated with negative slope portions of an accuracy plot, which are avoided as described below. This allows the accuracy to be continuously maintained and/or increased.

Although the disclosed figures are primarily described with respect to vehicle implementations, the systems, modules, and devices disclosed herein may be used for other applications, where artificial intelligence decisions are made and course of actions are selected. The examples may be utilized and/or modified for various neural networks.

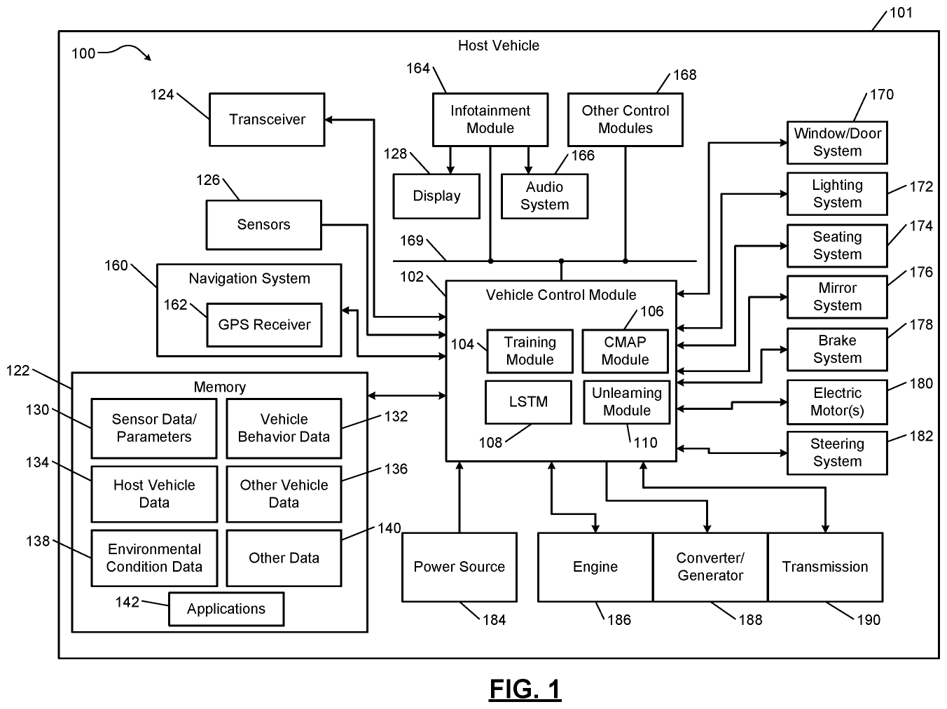

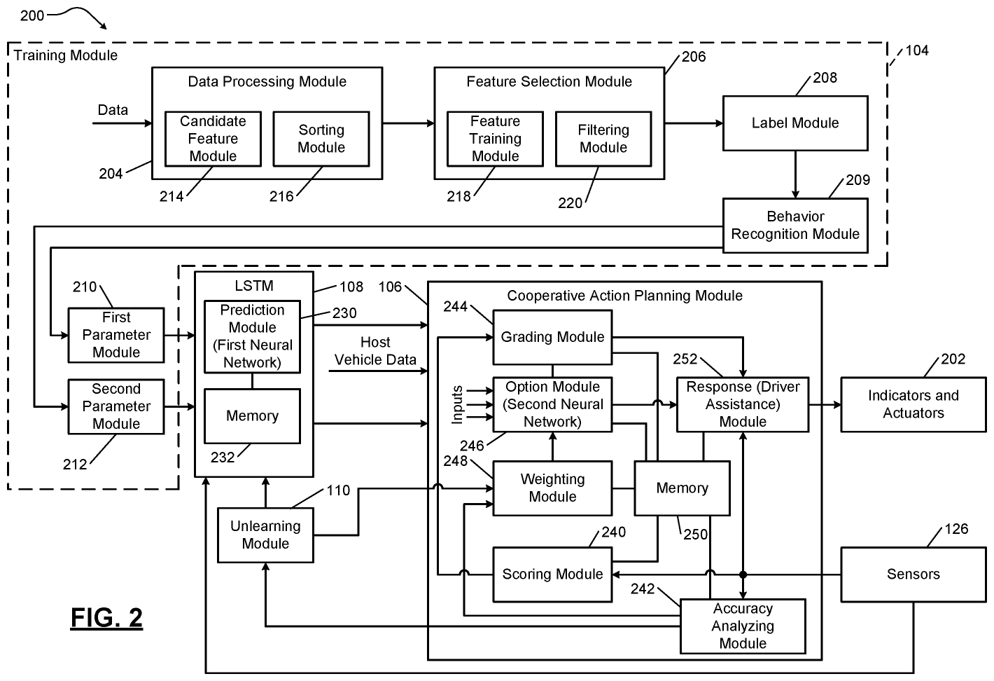

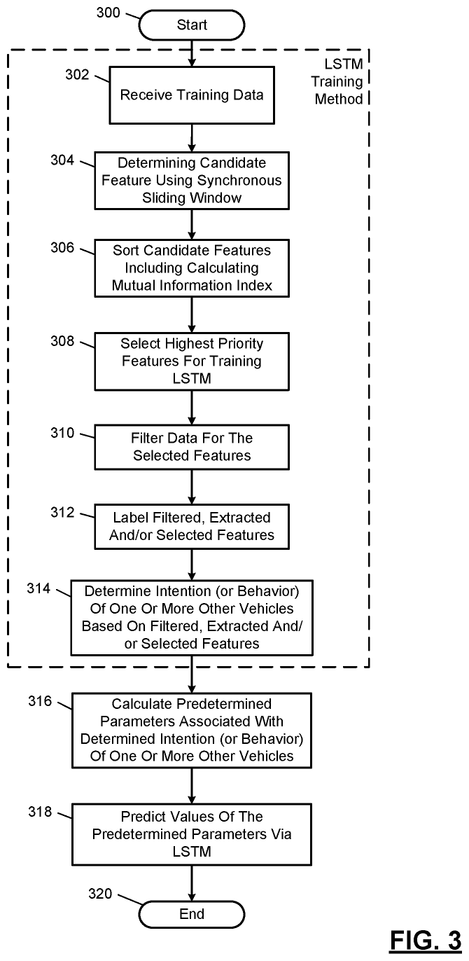

FIG. 1 shows a driver assistance system 100 of a host vehicle 101 incorporating a vehicle control module 102 having a training module 104, a cooperative action planning module 106 (may be referred to as a cooperative multi-agent planner (CMAP)), a LSTM 108, and an unlearning module 110. The training module 104 trains a first neural network of the LSTM 108. Operations of the training module 104 are described with respect to the method of FIG. 3. The cooperative action planning module 106 determines courses of action based on outputs of the LSTM 108. The LSTM 108 predicts parameters associated with actions to be performed by vehicles in a close proximity to the host vehicle 101. The cooperative action planning module 106 is further described below with respect to FIGS. 2 and 4-10. The unlearning module 110 is described below with respect to FIGS. 2, 4 and 7.

The host vehicle 101 may also include a memory 122, a transceiver 124, sensors 126, and a display 128. The memory 122 may store, for example, data referred to herein including: vehicle sensor data and/or parameters 130; vehicle behavior data 132 of the host vehicle 101 and/or of other vehicles; host vehicle data 134; data of other vehicles 136; environmental condition data 138; and other data 140. The stated vehicle data may include vehicle-to-vehicle data transmitted between vehicles via the transceiver 124. The memory may also store applications 142, which may be executed by the vehicle control module 102 to perform operations described herein. The sensors 126 may include, for example, a speed sensor, an acceleration sensor, proximity sensors, an accelerator pedal position sensor, a brake pedal position sensor, a steering wheel position sensor, etc. The sensors 126 may include cameras, objection detection sensors, temperature sensors, accelerometers (or acceleration sensors for detecting acceleration in X, Y, Z directions or yaw, pitch and roll), a vehicle velocity sensor and/or other sensors that provide parameters and/or data associated with the state of the vehicle 101, state of objects near the vehicle 101, and/or information regarding an environment in which the vehicle 101 is located. The sensors 126 detect environmental conditions and status of vehicle devices.

The display 146 may be a display on a dashboard of the host vehicle 101, a heads-up-display, or other display within the host vehicle 101 and used to provide driver assistance signals to a vehicle operator. Driver assistance signals may be generated by the response (or driver assistance) module 252 of FIG. 2.

The host vehicle 101 may further include a navigation system 160 with a global positioning system (GPS) receiver 162, an infotainment system 164, an audio system 166 and other control module 168, such as an engine control module, a transmission control module, a motor control module, an autonomous control module, a hybrid control module, etc. The navigation system 160 and GPS receiver 162 may be used to monitor locations of the host vehicle 101 and other vehicles and predict paths of the host vehicle 101 and the other vehicles. The GPS receiver 162 may provide velocity and/or direction (or heading) of the host vehicle 101. The display 128, the infotainment module 164, and the audio system 166 may be used to alert a drive of the host vehicle 101 and/or to receive requests from the driver.

The host vehicle 101 may include a window/door system 170, a lighting system 172, a seating system 174, a mirror system 176, a brake system 178, electric motors 180, a steering system 182, a power source 184, an engine 186, a converter/generator 188, a transmission 190, and/or other vehicle devices, systems, actuators, and/or components. The stated items 170, 172, 174, 176, 178, 180, 182, 186, 188, 190 may be controlled by the vehicle control module 102 and/or the cooperative action planning module 106. The cooperative action planning module 106 may select a course of action and single one or more of the stated items to perform certain actions. As an example, the cooperative action planning module 106 may decide to merge the vehicle 101 into an adjacent lane and/or to turn the host vehicle 101 to avoid a collision. This may include signaling the steering system 182 to steer the vehicle into the adjacent lane or to make a left or right turn. The cooperative action planning module 106 may signal the stated items to perform various autonomous operations.

The vehicle control module 102, the infotainment module 164, and other control modules 168 may communicate with each other via a controller area network (CAN) bus 169. The vehicle control module 102 may communicate with vehicle control modules of other vehicles via the transceiver 124. The vehicle control modules may share information regarding location, speed, acceleration, heading, predicted path, and/or other vehicle related information for each corresponding vehicle and/or other detected vehicles.

The vehicle control module 102 may control operation of the items 170, 172, 174, 176, 178, 180, 182, 186, 188, 190 according to parameters set by the vehicle control module 102 and/or one or more of the other modules 168. The vehicle control module 102 may receive power from a power source 184 which may be provided to the engine 186, the converter/generator 188, the transmission 190, the window/door system 170, the lighting system 172, the seating system 174, the mirror system 176, the brake system 178, the electric motors 180 and/or the steering system 182, etc.

The engine 186, the converter/generator 188, the transmission 190, the window/door system 170, the lighting system 172, the seating system 174, the mirror system 176, the brake system 178, the electric motors 180 and/or the steering system 182 may include actuators controlled by the vehicle control module 102 to, for example, adjust fuel, spark, air flow, throttle position, pedal position, door locks, window position, seat angles, lumbar support positions and/or pressures, mirror position, stereo presets, etc. This control may be based on the outputs of the sensors 126, the navigation system 160, and the GPS receiver 162. The stated control may also be performed to match parameters of a user profile, which may be adjusted by a user. The audio system 166 may include a stereo having channel presets and volume settings that maybe set by a user and adjusted according to a user profile by one or more of the modules 102, 168.

FIG. 2 shows an artificial intelligence system 200 including a training module 104, the cooperative action planning module 106, the LSTM 108, the unlearning module 110, indicators and actuators 202, and the sensors 126. The training module 104 includes a data processing module 204, a feature selection module 206, a label module 208, a behavior recognition module 209, a first parameter module 210 and a second parameter module 212. The data processing module 204 includes a candidate feature module 214 and a sorting module 216. The feature selection module 206 includes a feature training module 218 and a filtering module 220. Operations of the modules 104, 204, 206, 208, 209, 210, 212, 214, 216, 218, 220 are described below with respect to FIG. 3.

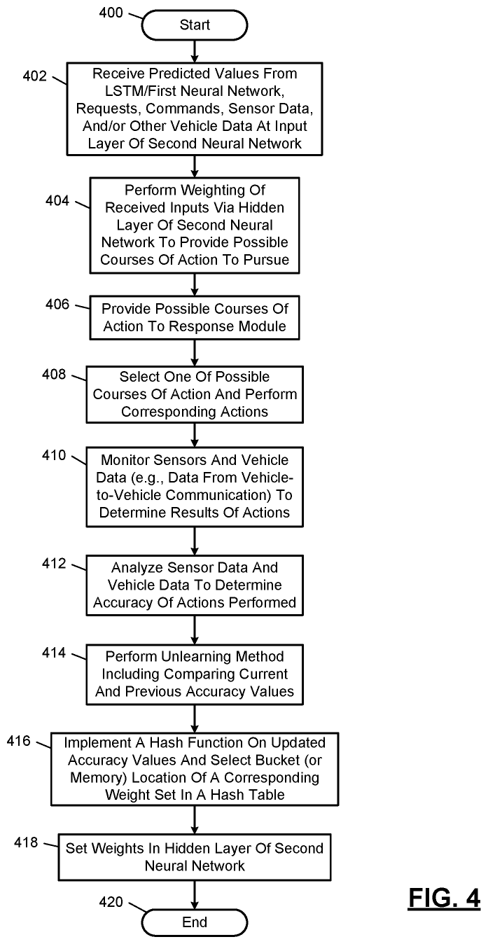

The LSTM 108 may include a prediction module 230, which may be implemented as a first neural network, and a memory 232. The operation of the LSTM and the prediction module 230 are described below with respect to FIG. 3. The cooperative action planning module 106 may include a scoring module 240, an accuracy analyzing module 242, a grading module 244, an option module 246, a weighting module 248, a memory 250, and a response module 252. In one embodiment, the scoring module 240 and the grading module 244 are implemented as a single module. The option module 246 may be implemented as a second neural network. Operations of the modules 106, 240, 242, 244, 246, 248, 252 are described below with respect to FIGS. 4-10.

The response module 252 may assist a driver of the host vehicle 101 of FIG. 1 by (i) passively by signaling the driver with suggested operations to perform and/or warning messages, and/or (ii) actively assisting and/or controlling operations of one or more actuators and/or devices of the vehicle 101, such as one or more of the items 170, 172, 174, 176, 178, 180, 182, 186, 188, 190. This may include adjusting set parameters of the host vehicle 101. The response module 252 may communicate with and/or receive vehicle behavior signals, driver assistance signals, and/or other signals from other vehicles and/or network devices (e.g., mobile devices, cloud-based devices, etc.) described herein via the transceiver 124.

The systems disclosed herein may be operated using numerous methods, example methods are illustrated in FIGS. 3, 4 and 9.

In FIG. 3, a LSTM operational method including a LSTM training method is shown. Although the following operations are primarily described with respect to the implementations of FIGS. 1-3, the operations may be easily modified to apply to other implementations of the present disclosure. The operations may be iteratively performed.

The method may begin at 300. The following operations 302-314 may be performed to train the LSTM 108 and/or corresponding first neural network. At 302, the data processing module 204 receives data, which may include simulation data, open source data, testing data, historical data, sensor data, etc. and/or other data describing different aspects of an environment. This data may include data pertaining to the host vehicle 101 and other vehicles. The data may be stored in the memory 122 and may be received from modules within the host vehicle 101 and/or a remote network device via the transceiver 124. The data may include, for example, vehicle acceleration data, vehicle velocity data, vehicle heading data, vehicle position data, etc. The data processing module 204 may receive data from the GPS receiver 162. The data may also include data received from and/or shared by one or more other vehicles.

At 304, the candidate feature module 214 generates candidate features using a synchronous sliding widow (SSW). The data received at 302, which may be saved in the memory 122, is processed using the SSW in order to extract different features from the data. The features may include, for example, lateral speed, lateral acceleration, longitudinal speed, longitudinal acceleration, etc. of each vehicle. In one embodiment, 93 different features are extracted; however, any number of features may be extracted.

At 306, the sorting module 216 sorts the candidate features by generating and/or calculating a mutual information index (MII). For example, the candidate features (e.g., the 93 candidate features) are ranked and indexed based on importance. In one embodiment, each of the candidate features are ranked based on how much information can be obtained, calculated, extracted, and/or determined based on the candidate feature fᵢ and be used to determine a particular vehicle behavior bⱼ, where i is the number of the feature and j is the number of the behavior. As an example, a candidate feature may be “acceleration”, and from this feature multiple other features may be extracted, such as acceleration in multiple directions, speed and/or distance traveled. These features may be used to determine whether a vehicle is exhibiting a behavior of drifting, stopping, approaching a host vehicle, moving away from the host vehicle, turning, etc.

At 308, the feature training module 218 selects a predetermined number of best candidate features based on the MII using a preselected machine learning algorithm, such as a random forest algorithm. The random forest algorithm is a learning algorithm that uses decision trees to provide a set of best features to use in following operations. The predetermined number of best features may be selected based on the rank and/or based on which features provide a highest operating efficiency in performance and/or a highest accuracy in host vehicle behavior. The random forest algorithm includes the use of an effective combination of a predetermined number of decision trees to provide the predetermined number of best candidate features.

A training set of the received data may be used to determine the predetermined number of best features. A portion of the training set of data may be used for validation purposes. In one embodiment, 80% of the received data is used for training and 20% of the received data is used to verify accuracy of the trees and selected features. This accuracy may be determined, for example by the accuracy analyzing module 242. The accuracy refers to whether the vehicle performed appropriately for a specific situation. Multiple different actions may be performed for a particular situation and be accurate. For example to avoid a collision, a vehicle may change lanes, slow down, and/or turn. Each of these maneuvers may be accurate, however each of these maneuvers may have a different associated efficiency (e.g., in time performed, fuel consumption, etc.).

Each of the decision trees may receive a different combination or group of the candidate features (e.g., the 93 features). The groups of candidate features may be distinct and/or overlap, such that two or more of the groups include one or more of the same candidate features. The decision trees output the best predetermined number of features, which are then used in the following operations. By using a reduced number of features, efficiency of the following operations is improved, such that decisions are made in a shorter period of time. This allows for fast predictions by the LSTM 108 and fast course of action determinations by the response module 252. In one embodiment, a combination of a predetermined number of decision trees and a predetermined number of best features is determined for maximum efficient. As an example, 25 decision trees may be used to provide 15 best features. As another example, the 15 best features may include coefficient of variation of lateral speed, Shannon Entropy of lateral acceleration, square root of lateral speed, current lateral speed, mean of lateral deviation (or drifting), square root of lateral acceleration, standard deviation of lateral speed, standard deviation of lateral acceleration, and coefficient of variation of lateral deviation. The amount of data for each of these features may be for a predetermined period of time (e.g., 2-4 seconds). A different amount of data corresponding to a different amount of time may be used for different ones of the features.

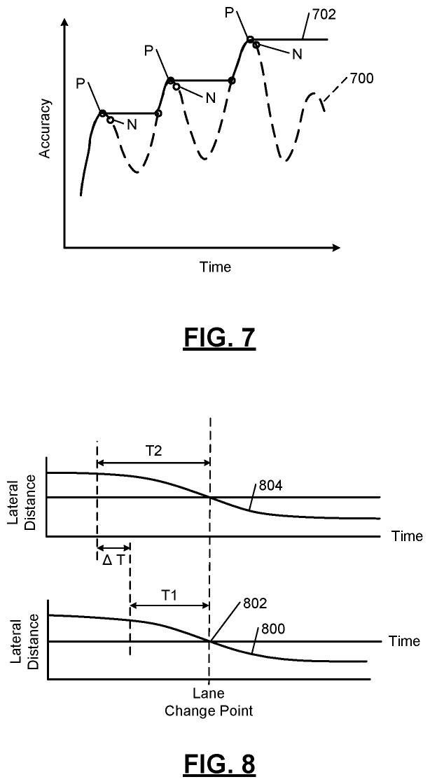

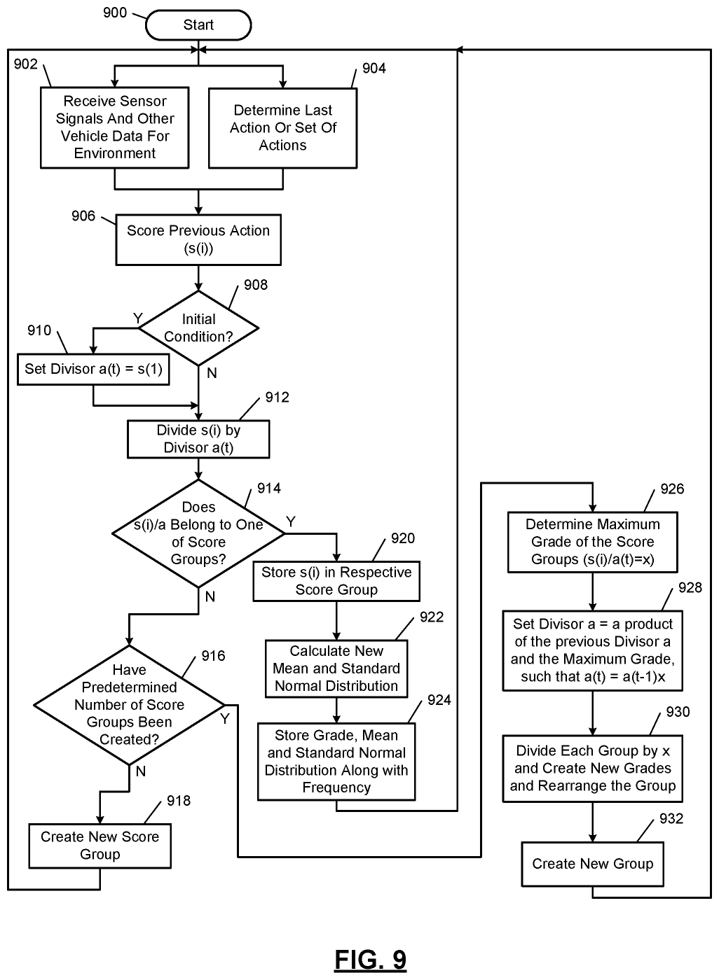

At 310, the filtering module 220 filters the data of the best (predetermined number of selected candidate) features using, for example, a Dempster Shafer evidence theory filtering algorithm. This may include smoothing the data to remove sporadic outliers or inconsistencies. The data is filtered to remove noise. The filtering is also done to improve time effectiveness and thus efficiency. An example of improved prediction efficiency is illustrated in FIG. 8.

The following two operations 312, 214 may be performed by the different modules or by a same module. At 312, the label module 208 labels the selected (or best) features and/or behaviors (sometimes referred to as intentions of other vehicles or other vehicle drivers) associated with the selected features and information extracted from the selected features. At 314, the behavior recognition module 209 determines a vehicle behavior based on the selected features, the information extracted from the selected features, and/or the labels. This may include determining behavior of a nearby vehicle relative to the host vehicle. The host vehicle may, for example, be changing lanes and the behavior recognition module 209 predicts the behavior of the nearby vehicle based on a predetermined set of rules, which may be stored in the memory 122. This behavior may be predicted for a predetermined period of time.

At 316, the first parameter module 210 and the second parameter module 212, based on the predicted behavior identified by the behavior recognition module 209, determine certain parameters of the nearby vehicle for a first predetermined period of time. The AI system 200 and/or the behavior recognition module 209 are trained to recognize certain behavior of vehicles. The parameters may be calculated based on the filtered data from the filtering module 220. As an example, the first parameter module 210 may calculate lateral deviation of the nearby vehicle for the predicted behavior. As another example, the second parameter module 212 may calculate longitudinal speed and acceleration of the nearby vehicle for the predicted behavior. The calculated parameters are forwarded to the LSTM 108 for future path prediction of the nearby vehicle.

The above-stated operations are performed to train the LSTM 108. This may be done through simulation. As an example, the accuracy analyzing module 242 may monitor actions performed as a result of predictions made by the LSTM 108 for the calculated parameters and determine accuracy of the actions performed. The training is determined to be completed when a maximum accuracy is reached and maintained for a predetermined period of time and/or a predetermined number of iterations have been performed. During training, the selected features may be changed, the predicted behavior may be changed for a same or similar situation, and/or the parameters calculated by the parameter modules 210, 212 may be changed to provide a maximum accuracy and corresponding efficiency.

At 318, the LSTM 108 and/or prediction module 230 predicts values of the parameters calculated by the parameter modules 210, 212 for a second period of time that is subsequent to the first period of time. The predicted values along with host vehicle data are provided to the cooperative action planning module 106. The host vehicle data may include simulation data, open source data, testing data, historical data, sensor data, and/or other data pertaining to the host vehicle 101. The method may end at 320.

The method of FIG. 4 may be performed subsequent to the method of FIG. 3. In one embodiment, the methods of FIGS. 3 and 4 are implemented as a single method and are iteratively performed. When training is completed, actual current sensor data, vehicle-to-vehicle data, and other condition and environmental data may be provided to the data processing module 204, the LSTM 108 and/or the option module 248 and used to determine best courses of action via the response module 252. The training module 104 may not be used when training is completed.

In FIG. 4, a course of action selection method implemented by the cooperative action planning module 106 is shown. Although the following operations are primarily described with respect to the implementations of FIGS. 1-2 and 4-10, the operations may be easily modified to apply to other implementations of the present disclosure. The operations may be iteratively performed. The cooperative action planning module 106 implements a reinforcement learning algorithm (or second neural network) and a grading method to determine a best course of action. As an example, the cooperative action planning module 106 may determine best actions to perform to merge into a nearby lane of traffic. The reinforcement learning algorithm may calculate all possible paths and prioritized the paths to indicate a best path to follow. The reinforcement learning algorithm may quickly determine whether to cooperate with a nearby vehicle or perform the merge without cooperating with the nearby vehicle. The reinforcement learning algorithm may determine a best nearby vehicle to cooperate with and the host vehicle and the best nearby vehicle then perform minimal operations and/or changes in current operations to avoid a collision with each other. The grading method aids in providing a best solution for a predictive economical merge.

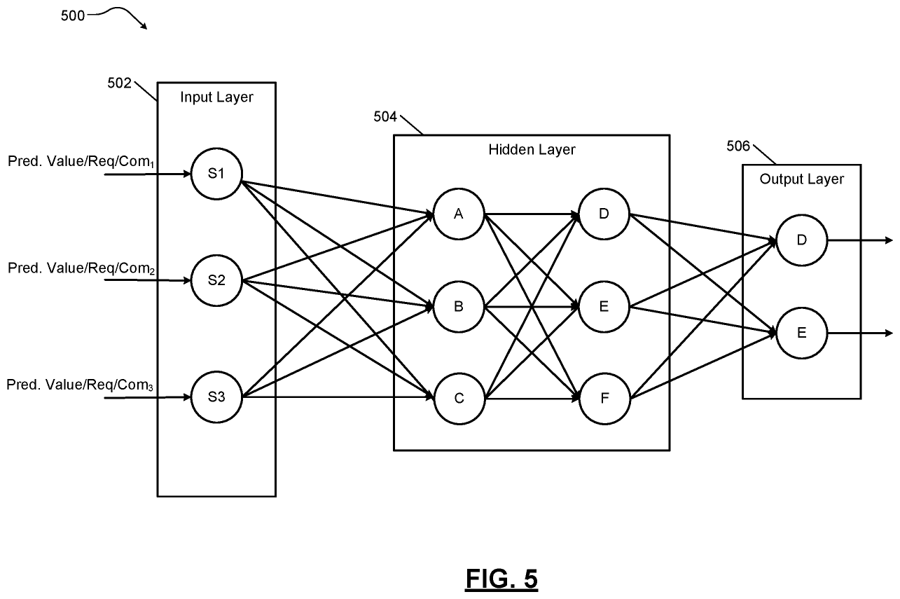

The method may begin at 400. At 402, an input layer of the option module 246 receives the predicted values and the host vehicle data from the LSTM 108 and memory 122. The option module 246 implements the second neural network. FIG. 5 shows an example of the second neural network 500 of the option module 246. The second neural network 500 includes an input layer 502, one or more hidden layers 504 and an output layer 506. Each of the layers 502, 504, 506 may have any number of inputs and outputs, although a particular number of each is shown.

At 404, the hidden layer of the option module 246 performs weighting operations on the inputs received at the input layer 502. FIG. 5 shows neurons A-F, which may each apply a weighting to values received by the input layer 502 or a previous neuron. The weights that are applied are determined by the weighting module 248 in the following operation 418. In one embodiment, the outputs of the second hidden layer 504 are possible accurate courses of action that may be pursued by the response module 252. For example, the outputs may be different routes that the host vehicle 101 may follow to arrive at a particular destination or to avoid a collision. At 406, the output layer 506 of the option module 246 provides the possible accurate courses of action to the response module 252.

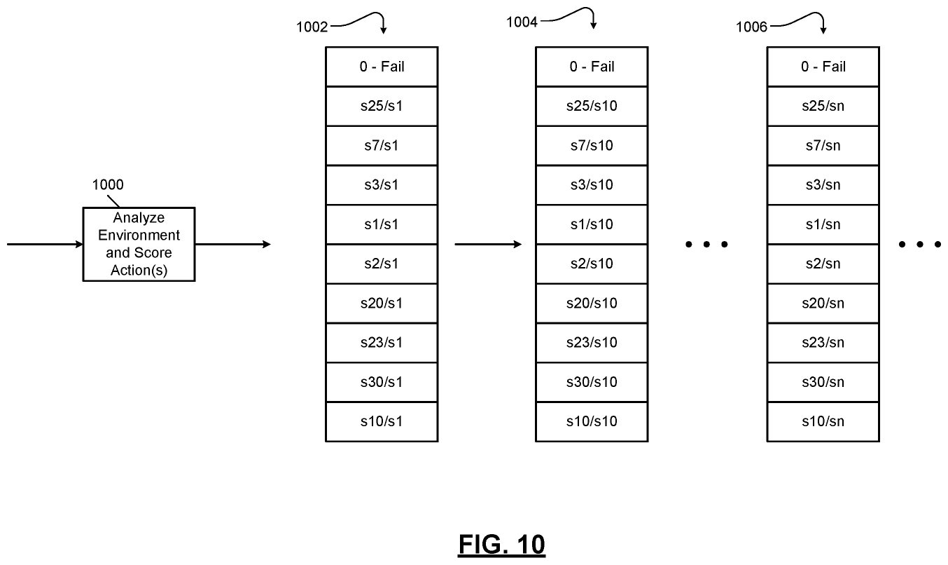

At 408, the response module 252 selects one of the possible courses of action and performs corresponding actions. This may include generating signals to control the indicators and actuators 202, such as any of items 128, 164, 166, 168, 170, 172,174, 176, 178, 180, 182, 186, 188, 190 of FIG. 1. The signals may include signals to warn and/or guide a driver of the host vehicle 101 and/or signals to autonomously control operation of the host vehicle 101. The course of action with the best associated efficiency may be selected by the response module 252. The response module 252 may perform data mining to find accurate actions to perform. In one embodiment, the response module 252 selects a course of action and/or corresponding actions that provide a maximum efficiency and have a highest grade as determined by the grading module 244. By selecting the course of action with the highest grade, the response module 252 selects the course of action with the highest efficiency. In another embodiment, the grading module 244 grades the possible courses of action determined by the option module 246 and selects the course of action with the highest efficiency, which is then selected and followed by the response module 252. Operation of the grading module 244 is further described below with respect to FIGS. 9-10.

At 410, the cooperative action planning module 106 including the modules 240, 242 monitor outputs of the sensors 126, the GPS receiver 162, and data associated with vehicle-to-vehicle communication to determine results of actions performed by the indicators and actuators 202. At 412, the accuracy analyzing module 242 determines the accuracy level of the actions performed. Continuing from an above example, if the host vehicle 101 arrives at the intended location, avoids a collision, and/or satisfies some other criteria, then the actions are deemed accurate. If the host vehicle 101 does not arrive at the intended location, does not avoid a collision, and/or does not satisfy one or more of the other criteria, then the actions are deemed inaccurate. The accuracy analyzing module 242 may determine levels of accuracy for each action or set of actions performed. More than two levels of accuracy may be selected from when determining the accuracy level of each action or set of actions performed. The accuracy analyzing module 242 may create and maintain an accuracy table for storing actions performed relative to the corresponding accuracy levels determined. The accuracy table may be stored in the memory 250. Operation of the scoring module is described below with respect to FIGS. 9-10.

At 414, the unlearning module 110 performs an unlearning method, which includes comparing current and previous accuracy level values. The accuracy table may be modified as per the training performed. When the table learns that the learning is causing the accuracy level of a course of action to decrease and/or provide a negative slope in a corresponding accuracy curve, the accuracy analyzing module 242 signals the weighting module 248 to modify the weights applied to neurons of the first neural network of the LSTM 108. This may include reverting back to a last weight set for a last local maximum accuracy level. Although the unlearning method is primarily described with respect to the weights applied to neurons of the first neural network, the unlearning method may also be similarly applied to the neurons of the second neural network of the option module 246. This helps to prevent negative slopes and ignores or eliminates corrupt data.

FIG. 7 shows accuracy over time plots illustrating detection of a negative slope and accuracy by maintaining previous weight set values. A first accuracy plot 700 is shown and a modified accuracy plot 702 is shown for the accuracy of the system due to the weighting modifications. Each point on the accuracy curve has an associated weight set for the neurons of the hidden layer 504. When a local maximum peak in accuracy and/or a negative slope in the first accuracy plot 700 is detected, weighting is returned to a previous weight set associated with the last local maximum accuracy. This allows the actual accuracy to be similar to the accuracy plot 702, such that the accuracy is either maintained or increased. Example points P are shown for local maximums. Example points N are shown that are associated with negative slopes.

In addition to negative slope periods, corrupt data may reduce accuracy of a neural network. The unlearning method is used to skip the negative slope and corrupt data to achieve maximum accuracy. For training the second neural network, a hash table that relates memory addresses to weights sets for the neurons of the corresponding neural network is maintained. Hash tables may be stored in the memory 122, 232 and/or 250.

To detect a negative slope, the accuracy is monitored for short consecutive predetermined periods. For each of the periods, the slope of the corresponding portion of the accuracy curve is calculated. When a negative slope is detected, weights of the entire corresponding neural network may be altered to previous weights. The previous weights are stored in the corresponding hash table. With respect to the second neural network, the hash table may be used by the weighting module 248 to convert accuracy values received from the accuracy analyzing module 242 to memory addresses of stored weight sets.

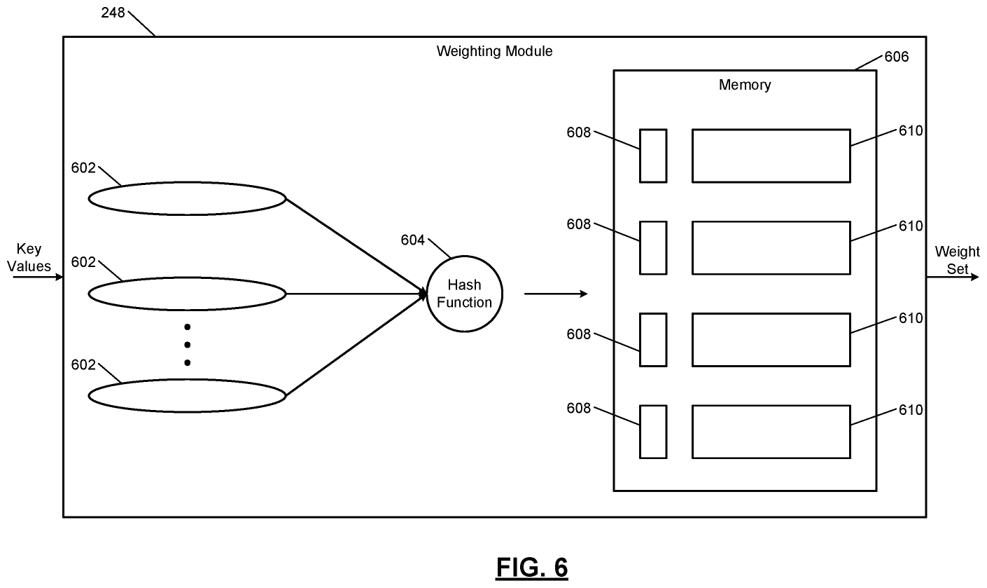

FIG. 6 shows an example of the weighting module 248. The weighting module 248 may include keys 602, a hash function 604, and a memory 606. The memory 606 may store, at memory locations of addresses 608, weight sets 610. In an embodiment, the keys (or key values) are accuracy values received from the accuracy analyzing module 242. The hash function 604 converts the keys 602 to one of the addresses 608 to select one of the weight sets 610. The selected weight set is provided to the option module 246 for the neurons of the second neural network.

Although a hash function and corresponding table are described, other algorithms may be used to select and/or determine a weight set. When the accuracy analyzing module 242 detects a negative slope, the previous weight set with the last maximum accuracy is stored in the option module 246. When the accuracy analyzing module 242 detects that the accuracy is increasing, the weights are continued to be updated for the increased accuracy values. This allows the corresponding system to continue to perform training operations while increasing accuracy.

At 416, the weighting module 248 implements the hash function on updated accuracy values and selects a bucket (or memory) location for a corresponding weight set as described above. At 418, the option module 246 applies the selected weights in the hidden layer 504 of the second neural network. The method may end at 420.

FIG. 8 shows lateral distance over time plots illustrating a reduced amount of time to predict a lane change event as a result of filtering data of selected best features. A first lateral distance over time plot 800 has a first amount of time T1 associated with predicting a lane change event. A lane change (or when the vehicle crosses from a first lane into a second lane) occurs essentially at point 802. An example amount of time T1 for an AI system to predict the lane change is shown. By implementing the filtering performed by the filtering module 220 of FIG. 2, the AI system may predict a lane change earlier as illustrated by the time T2 corresponding to a second lateral distance over time plot 804. The difference in the amounts of time between T1 and T2 is illustrated by AT.

In FIG. 9, a grading method is shown. Although the following operations are primarily described with respect to the implementations of FIGS. 1-2 and 9-10, the operations may be easily modified to apply to other implementations of the present disclosure. The operations may be iteratively performed.

The method may begin at 900. Operation 902 may be performed while performing operation 904. At 902, the scoring module 240 receives data from the memory 250, the sensors 126 and/or other data pertinent to describing aspects of a current environment and/or situation the host vehicle 101 is currently experiencing and/or is being trained to experience. At 904, the scoring module 240 detects what action or set of actions were last performed. At 906, the scoring module 240 scores the last performed action and/or set of actions based on (i) the data received at 902, (ii) a latest generated mean of scores, (iii) a latest generated standard normal distribution of scores and/or (iv) a frequency of occurrence of each score. The score is represented as s(i), where i is the current iteration of the method. In one embodiment, the score indicates or is related to: an amount of corresponding fuel consumption to perform the action or set of actions; braking efficiency involved to perform the action or set of actions (e.g., distance to come to a complete stop); an amount of communication exhibited between the host vehicle 101 and one or more other vehicles to coordinate the action or set of actions; time involved to perform the action or set of actions; and/or other efficiency parameters. The score(s) resulting from performing operation 906 may be stored in the memory 250.

The following operations may be performed by the grading module 244. At 908, the grading module 244 determines whether the host vehicle 101 is experiencing an initial condition or first environmental situation, where groups of scores have not been created. If this is an initial condition or first environmental situation, then perform operation 910 is performed, otherwise operation 912 is performed. At 910, a divisor a(t) is set equal to s(1), where s(1) is the score determined at 906 and t refers to a current iteration time period.

At 912, the score s(i) for the current iteration of the method is divided by the divisor a(t). At 914, the grading module 244 determines whether s(i)/a(t) belongs to one of the existing score groups when one or more score groups were previously created. Each score group may correspond to a range of scores and may be assigned a grade (e.g., 10%, 20%, 30% . . . ). As an example, if 10 score groups have been created and the range of scores is from 0-1, then each score group may be associated with a respective 10% range. The scores may refer to or be directly related to efficiency. For example, a first score group may include scores from 0-0.10, a second score group may include scores from 0.11-0.20, etc. If this is a first iteration of the method, no score group may exist. If s(i)/a(t) does not belong to one of the existing score groups, then operation 916 is performed, otherwise operation 920 is performed.

At 916, the grading module 244 determines whether a predetermined number of score groups have been created. In one embodiment, the predetermined number is 10, although any number of score groups may be created. If a predetermined number of score groups have not been created, operation 918 is performed, otherwise operation 926 is performed.

At 918, the grading module 244 creates a new score group for s(i). Operations 902, 904 are performed subsequent to operation 918.

At 920, the grading module 244 stores the score s(i) in an area of memory 250 allocated for a corresponding score group. The identification of the score group may be referred to as the grade for that score. The corresponding score group has an associated range of scores that includes the score s(i). If the score refers to a failure, the score may be saved in an area of memory allocated to a “0 score group”, whereas if the score is not a failure, then the score may be saved in an area of memory allocated to one of the other created score groups per the corresponding efficiency and/or based on a corresponding grading scale.

At 922, the grading module 244 calculates a new mean and standard normal distribution of the scores stored in the memory 250 and associated with the actions performed. At 924, the grading module 244 may (i) store the new mean and standard normal distribution of the scores, and (ii) store or update frequencies of occurrences of each of the scores in the memory 250 for subsequent iterations.

The grading module 244 may grade the outputs of the second neural network as described above. This may be based on the scores in the groups, the mean, the standard normal distribution and/or the frequencies of occurrences. The grades may be determined using hybrid or embedded machine learning techniques, such as a Random Forest algorithm, a convolutional neural network (CNN) for classifying or grading the action(s). The grades may be values between 0-1, maximum values assigned to each score group, or other suitable grades. In an embodiment, the course of action having a score that corresponds to the mean and/or having the highest frequency of occurrence is selected. The response module 252 makes course of action decisions based on the grades. Operations 902, 904 may be performed subsequent to operation 924.

At 926, the grading module 244 determines a maximum grade x of the score groups that has been created, which is equal to s(i)/a(t). At 928, the grading module 244 sets the divisor a(t) equal to a product of the previous divisor a(t−1) and the maximum score x, where a(t)=a(t−1)x.

At 930, the grading module 244 reconfigures the score groups and redistributes the scores by dividing each score group by x and creates new or updated score groups and reassigns the corresponding scores to the new or updated score groups. At 932, the grading module creates a new score group for the current score.

The above-described unlearning and grading methods are performed to improve learning of the second neural network. The grading method is performed to increase efficiency and is generalized for when: best (or ideal) actions for maximum efficiency are unknown; what maximum efficiency can be is unknown; and variance of scores for actions performed is unknown. If ideal conditions and/or a situation for maximum efficiency are known, then the grading for current actions can be based on the particular actions performed to provide the maximum efficiency. For this a prior test needs to be performed and a frequency of scores, which are greater than an expected score, is stored. This can require a substantial amount of time and the system is not generalized for various situations including unknown and/or unaccounted for situations. In contrast, systems disclosed herein implement the method of FIG. 9 to provide automatic and continuous training and thus are generalized. It can be difficult to train a system if information about ideal actions for maximum efficiency is unknown. The method of FIG. 9 provides a generalized method that includes grading and storing frequency of occurrence of particular data. A broad set of analytical tools, such as Gaussian analysis or classical statistics that are adapted to a specific data type or application may be used.

FIG. 10 shows creating and updating score groups of scores of actions performed for certain conditions. Block 1000 refers to analyzing an environment and scoring action(s) performed as described above by the accuracy analyzing module 242 and the scoring module 240. Each resulting score as described above for operations 910 and 912 is divided by the divisor a(t), where a is equal to s(1). In the example shown, 10 score groups are provided, where a maximum difference between the score groups is 0.1. If a score is generated that does not belong to any of the score groups 0, s25, s7, s3, s1, s2, s20, s23, s30, s10 for a current iteration 1002, then score groups are redistributed as described above for operations 914, 926, 928, 930 and a new score group is created at 932. The score groups of the current iteration 1002 are shown in order of efficiency. The reconfiguring of the score groups may include changing the score ranges of each of the score groups. In one embodiment, the sizes of the ranges of the score groups are different unlike that shown in FIG. 10. The same number of score groups may exist subsequent to reconfiguring and generation of the new score group as prior to reconfiguring and generation of the new score group, as shown in FIG. 10. In one embodiment, the number of score groups is increased (or incremented by 1) subsequent to reconfiguring and generation of the new score group.

A new series (or set) of score groups is created to provide iteration 1004. The divisor a(t) is set equal to a product of s(1) and a maximum score of the groups, which is s1*s10, where s10 is the maximum score of the groups. The score groups of the iteration 1004 are shown in order of efficiency, where 0 is the worst efficiency and s10 is the highest efficiency. This may be iteratively performed as further illustrated by iteration 1006 (or iteration n, where n is an integer greater than 2), where a(t)=a(t−1)*max (score of the groups). Each score group has score values and corresponding frequencies of occurrence. Each group may be weighted based on the frequency, the more occurrences for a score group, the higher the weighting of that score group.

The above-described operations of FIGS. 3, 4 and 9 are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The methods disclosed herein may be used for multi-lane maneuvering, hazard mitigation, crash avoidance, and/or other courses of action. The described methods provide generalized AI systems with learning algorithms providing maximum accuracy and increased efficiency over traditional systems.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An artificial intelligence system comprising:
a data processing module configured to, at a host vehicle, (i) receive training data associated with a plurality of features, (ii) based on the training data of the plurality of features, determine candidate features using a synchronous sliding window, and (iii) index and rank the candidate features;
a feature selection module configured to (i) select a predetermined number of the candidate features having higher priority than the other ones of the candidate features, and (ii) filtering the training data corresponding to the selected features to provide filtered data;
a behavior recognition module configured to determine a behavior of a remote vehicle based on the filtered data;
one or more parameter modules configured to determine one or more parameters of the remote vehicle relative to the host vehicle based on the determined behavior;
a long short term memory implementing a neural network and configured to receive the one or more parameters and predict one or more values of the one or more parameters; and
a driver assistance module configured to assist in operation of the host vehicle based on the predicted values.

2. The artificial intelligence system of claim 1, wherein the data processing module is configured to sort the candidate features to provide a mutual information index.

3. The artificial intelligence system of claim 1, wherein the feature selection module is configured to select the predetermined number of the candidate features according to a random forest algorithm.

4. The artificial intelligence system of claim 3, wherein a number of trees used by the random forest algorithm is greater than the predetermined number of candidate features.

5. The artificial intelligence system of claim 1, wherein the feature selection module is configured to filter the training data corresponding to the selected features using a Dempster Shafer evidence theory algorithm.

6. The artificial intelligence system of claim 1, further comprising an intention recognition label module configured to label the selected features or the behavior of the remote vehicle.

7. The artificial intelligence system of claim 1, wherein:
the one or more parameter modules comprise
a first parameter module configured to determine lateral deviation of the remote vehicle, and
a second parameter module configured to determine longitudinal speed and acceleration of the remote vehicle; and
the one or more parameters include the lateral deviation, the longitudinal speed and the acceleration of the remote vehicle.

8. The artificial intelligence system of claim 1, wherein the long short term memory is configured to predict the one or more values of the one or more parameters based on at least one of previous performed actions of the host vehicle, vehicle-to-vehicle data received in association with communication between the host vehicle and the remote vehicle, or sensor data.

9. The artificial intelligence system of claim 1, further comprising an unlearning module configured to (i) perform an unlearning method based on accuracy levels of actions performed as a result of courses of actions selected by the driver assistance module, and (ii) based on the accuracy levels, select a set of weights to adjust operation of the long short term memory,
wherein the long short term memory is configured to predict the one or more values of the one or more parameters based on the selected set of weights provided by the unlearning module.

10. The artificial intelligence system of claim 9, wherein:
the unlearning module selects the set of weights using a hash function and a hash table; and
the hash table identifies memory addresses of sets of weights including addresses of the set of weights.

11. A method of operating an artificial intelligence system, the method comprising:
receiving at a host vehicle training data associated with a plurality of features;
based on the training data of the plurality of features, determining candidate features using a synchronous sliding window;
indexing and ranking the candidate features;
selecting a predetermined number of the candidate features having higher priority than the other ones of the candidate features;
filtering the training data corresponding to the selected features to provide filtered data;
determining a behavior of a remote vehicle based on the filtered data;
determining one or more parameters of the remote vehicle relative to the host vehicle based on the determined behavior;
implementing a neural network via a long short term memory;
receiving the one or more parameters at the neural network and predicting one or more values of the one or more parameters; and
assisting in operation of the host vehicle based on the predicted values.

12. The method of claim 11, further comprising sorting the candidate features using a mutual information index.

13. The method stem of claim 11, further comprising selecting the predetermined number of the candidate features according to a random forest algorithm.

14. The method of claim 13, wherein a number of trees used by the random forest algorithm is greater than the predetermined number of candidate features.

15. The method of claim 11, comprising filtering the training data corresponding to the selected features using a Dempster Shafer evidence theory algorithm.

16. The method of claim 11, further comprising labeling the selected features or the behavior of the remote vehicle.

17. The method of claim 11, further comprising:
determining lateral deviation of the remote vehicle; and
determining longitudinal speed and acceleration of the remote vehicle,
wherein the one or more parameters include the lateral deviation, the longitudinal speed and the acceleration of the remote vehicle.

18. The method of claim 11, comprising predicting the one or more values of the one or more parameters based on at least one of previous performed actions of the host vehicle, vehicle-to-vehicle data received in association with communication between the host vehicle and the remote vehicle, or sensor data.

19. The method of claim 11, further comprising:
performing an unlearning method based on accuracy levels of actions performed as a result of courses of actions selected by the driver assistance module;
based on the accuracy levels, selecting a set of weights to adjust operation of the long short term memory; and
predicting the one or more values of the one or more parameters based on the selected set of weights provided by the unlearning module.

20. The method of claim 19, further comprising selecting the set of weights using a hash function and a hash table,
wherein the hash table identifies memory addresses of sets of weights including an addresses of the set of weights.
